(19) United States
(12) Patent Application Publication
(10) Pub. No.: US 2016/0098527 A1
(43) Pub. Date: Apr. 7, 2016

(54) PREDICTED AND TRACKED PERSONALIZED PATIENT TREATMENT EFFECTS ON BODY FUNCTIONS

(71) Applicant: KONINKLIJKE PHILIPS N.V., Eindhoven (NL)

(72) Inventors: Jingyu Zhang, Elmsford, NY (US); Colleen M. Ennett, White Plains, NY (US); Pavankumar Murli DADLANI MAHTANI, Eindhoven (NL)

(21) Appl. No.: 14/892,383

(22) PCT Filed: Jun. 4, 2014
(86) PCT No.: PCT/IB2014/061951

§ 371 Date: Nov. 19, 2015

Related U.S. Application Data
(60) Provisional application No. 61/838,371, filed on Jun. 24, 2013.

(51) Int. Cl. G06F 19/00

(52) U.S. Cl. CPC G06F 19/345; G06F 19/322; G06F 19/3487

(57) ABSTRACT

A medical information system (1) includes a user interface unit (2), a function predictor (6), a visualization unit (8), and a display device (12). The user interface unit (2) receives responses of a patient diagnosed with a disease to standardized questions pertaining to body functions of the diagnosed patient. The function predictor (6) computes predicted function values for the at least one body function based on the received responses, a disease profile, a treatment option, and a statistical model constructed from population based survey results. The visualization unit (8) constructs a visual display of the predicted values of the at least one body function for the diagnosed patient. The display device (12) displays the visual display.

The following relates generally to medical informatics, clinical and/or patient decision support. It finds particular application in conjunction with the prediction and tracking of patient body functions during treatment of a patient diagnosed with cancer, and will be described with particular reference thereto. However, it will be understood that it also finds application in other diseases and usage scenarios and is not necessarily limited to the aforementioned application.

Cancer patients are faced with a difficult decision making process once a cancer diagnosis is made where a patient selects among various treatments a particular treatment. Outcome information presented to the patient is generally limited to long-term generalized patient population statistics known to a particular practicing healthcare professional. Patient population statistics exist in abundance of forms and sources, but due to the volume and complexity they are not organized in a manner accessible and useful to a typical healthcare practitioner, much less a patient. The patient may be advised of potential risks, but the advisements lack quantification and again are based on long-term population statistical outcomes and typically fragmented by study. Some healthcare practitioners focus on survival rates in patient advisement. For example, a patient may be advised that a treatment may result in some loss in urinary function in the case of prostate cancer, but the survival rate based on population statistics is good. Another example is where the patient is advised that each of the treatments may result in loss of urinary function to varying degrees, again, in the case of prostate cancer. The information is usually presented verbally by a healthcare practitioner and may not accommodate the particular learning style or the ability to comprehend by the patient and/or an assisting healthcare practitioner.

Treatments for cancer involve side effects which change body functions. Examples of functions include pain, fatigue, breathing, range of motion, and the like, and specifically for prostate cancer, body functions like urinary function, erectile function, bowel function. A treatment can include side effects to one or more body functions. For example, with prostate cancer, which is a common cancer in men, treatment options include radical prostatectomy, external beam radiation therapy, brachytherapy, and active surveillance. Side effects of prostate cancer treatments can include changes to erectile, urinary, and bowel functions. With breast cancer, treatment options can include surgery, radiation, hormonal treatment, biological therapy, chemotherapy, etc. Side effects can include changes to body functions such as pain, breathing, wound healing, etc.

The outcomes of long-term patient populations do not provide information specific to the patient faced with the decision or to the healthcare practitioner assisting the patient in making the decision. Furthermore, the outcomes do not provide any measure of progression for the patient who selects a particular treatment option. Information provided in feedback to the patient during the first 24 months following selection of a treatment option may be verbally given as improved status or non-improved status, but lack information concerning the progression or tracking of specific body functions relative to achievable levels. For example, when a patient selects a treatment option such as radiation therapy, personalized information regarding how the patient is progressing with regards to impact on body functions is lacking and the patient is typically referred to information about the long-term population expected outcomes.

The following discloses a new and improved system and method of predicting and tracking personalized patient treatment effects on body functions which address the above referenced issues, and others.

In accordance with one aspect, a medical information system includes a user interface unit, a function predictor, a visualization unit, and a display device. The user interface unit receives responses of a patient diagnosed with a disease to standardized questions pertaining to body functions of the diagnosed patient. The function predictor computes predicted function values for the at least one body function based on the received responses, a disease profile, a treatment option, and a statistical model constructed from population based survey results. The visualization unit constructs a visual display of the predicted values of the at least one body function for the diagnosed patient. The display device displays the visual display.

In accordance with another aspect, a method of providing medical information for patients diagnosed with a disease includes receiving responses of a patient diagnosed with a disease to standardized questions pertaining to body functions of the diagnosed patient. Predicted function values are computed for at least one body function based on the received responses, a disease profile, a treatment option, and a statistical model constructed from population based survey results. A visual display of the predicted values of the at least one body function is constructed for the diagnosed patient. The visual display is displayed.

In accordance with another aspect, a cancer information system includes a user interface unit, a function predictor, a visualization unit, and a display device. The user interface unit receives responses of a patient diagnosed with cancer to questions pertaining to body functions of the diagnosed patient. The function predictor computes predicted values for the body functions and the treatment options based on the received responses, and at least one statistical model constructed from population based survey results. The visualization unit constructs graphical displays of the predicted values for the treatment options and the affected body functions. The display device displays the graphical displays.

One advantage is a personalized comparison of different treatment options for a patient and/or assisting healthcare practitioner.

Another advantage is the presentation of predicted patient functions for a selected treatment.

Another advantage resides in visualization of the comparison which accommodates different learning styles and/or understanding.

Another advantage is the short-term tracking of a patient's functions or recovery progression.

Still further advantages will be appreciated to those of ordinary skill in the art upon reading and understanding the following detailed description.

The invention may take form in various components and arrangements of components, and in various steps and arrangement of steps. The drawings are only for purposes of illustrating the preferred embodiments and are not to be construed as limiting the invention.

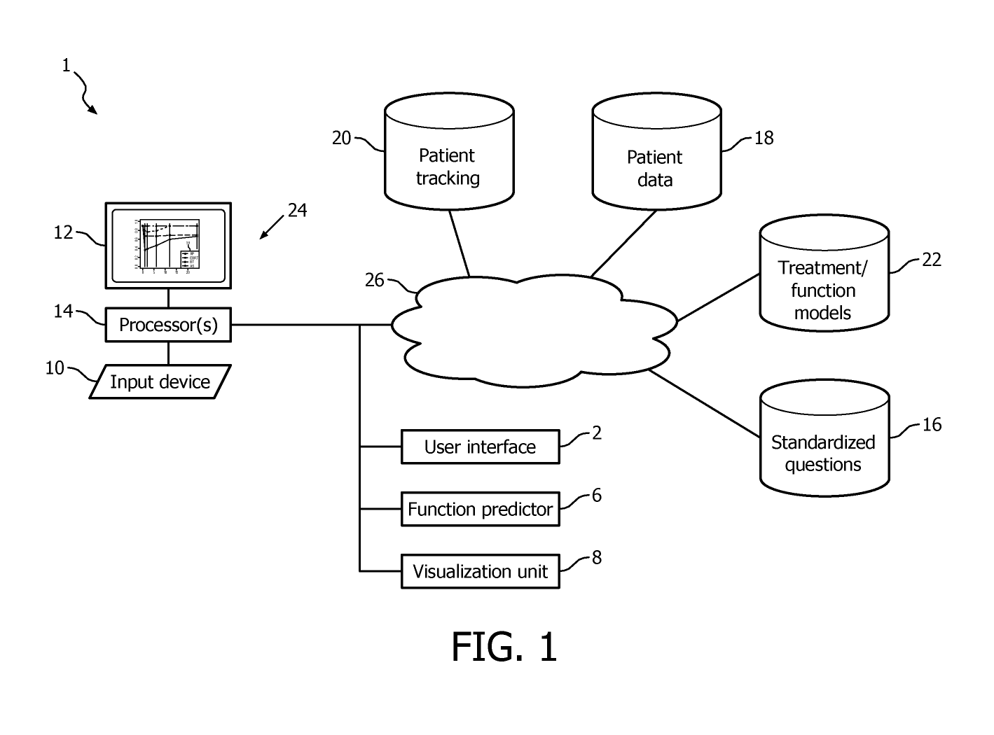

FIG. 1 schematically illustrates an embodiment of the predicted and tracked personalized patient treatment effects on body functions system.

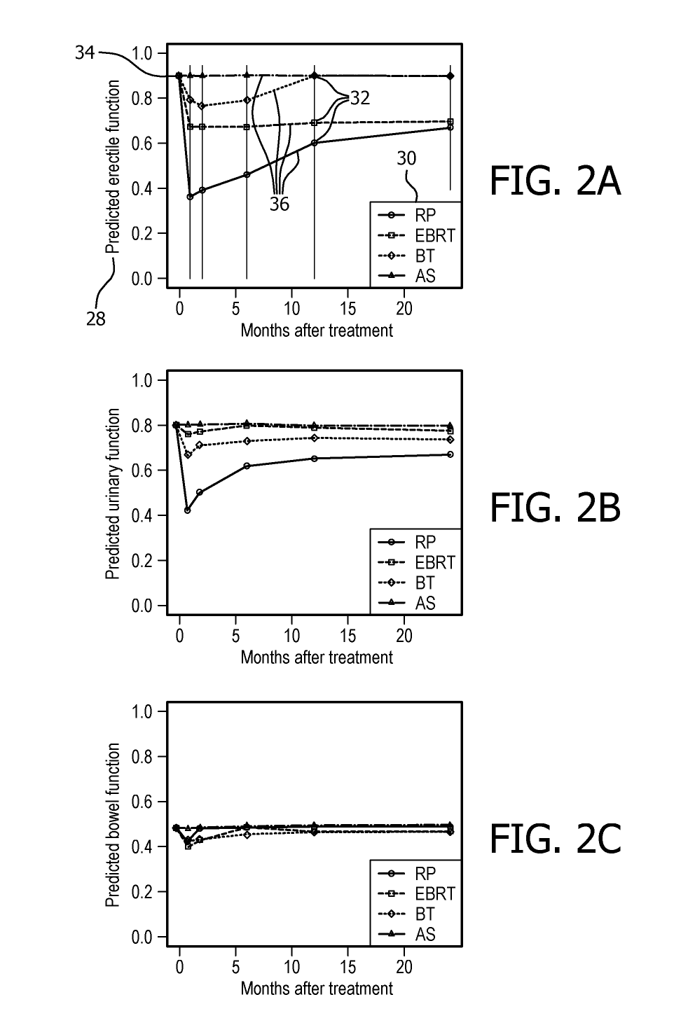

FIGS. 2A-2C illustrate example visualizations of predicted prostate cancer treatment options by body function.

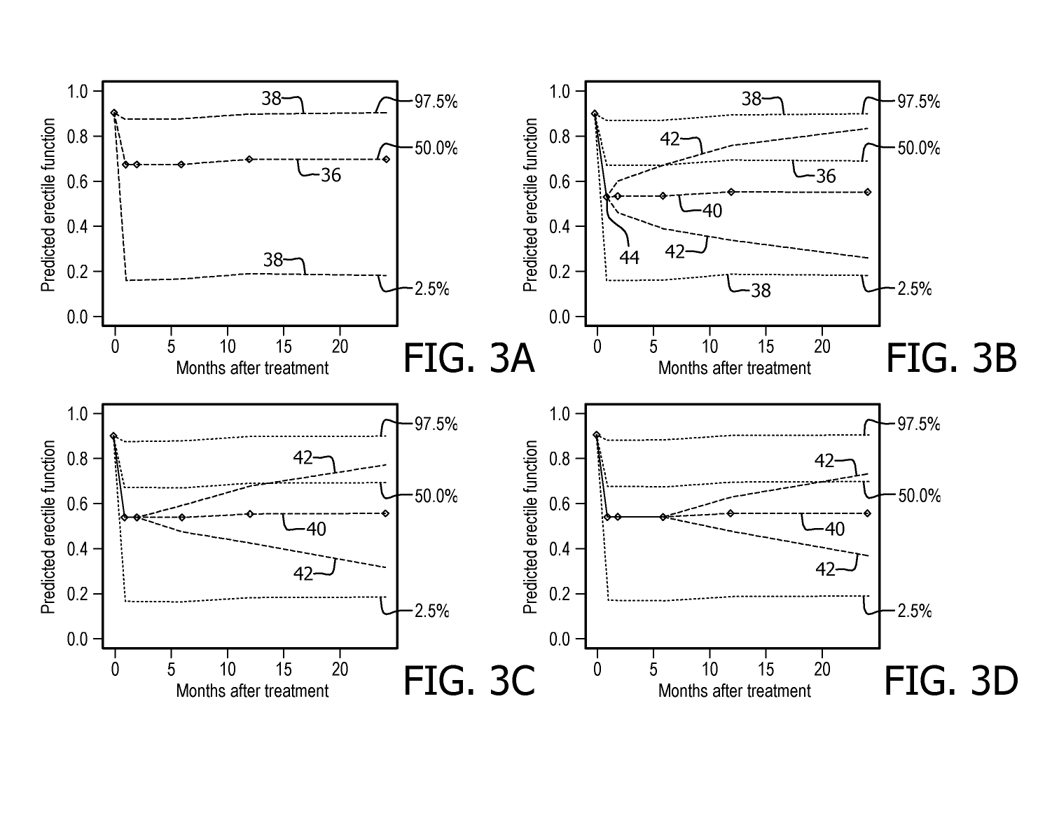

FIGS. 3A-3D illustrate example visualizations of short-term tracking of prostate cancer external beam radiation therapy treatment erectile function with confidence measures.

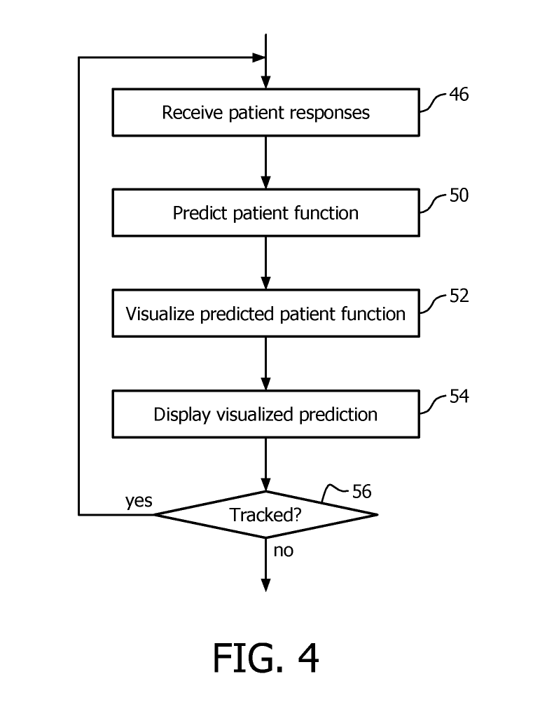

FIG. 4 illustrates an embodiment of a method of predicting and tracking patient body functions.

With reference to FIG. 1, an embodiment of the predicted and tracked personalized treatment effects on body functions system 1 is schematically illustrated. The system 1 includes a user interface 2, a function predictor 6, and a visualization unit 8. The user interface 2 includes at least one input device 10, a display device 12, and one or more processors 14, and a data store of standardized questions 16. The user interface retrieves selected questions from the data store of standardized questions 16, displays the questions on the display device 12 to a patient or assisting healthcare practitioner, and receives responses to the standardized questions from the input device 10. The patient is diagnosed with a disease, which is identified from a disease profile. The disease profile can be obtained from patient data 18 either directly from a medical record and/or a data store entered manually. The disease profile can include diseases other than the disease for which the patient is evaluating treatment options. The standardized questions elicit responses to determine current or actual body functions of the patient. The questions are based on the patient disease profile. For example, a patient diagnosed with prostate cancer includes questions about erectile, urinary, and bowel functions.

The function predictor computes current or actual body function values and predicted body function values based on the received responses to questions, the treatment option, the disease profile and a statistical model. For example, an actual percentage level of function or dysfunction between 0-100% is computed for each of erectile, urinary, and bowel functions for a prostate cancer patient. A disease profile can be associated with a single function such as healing or multiple body functions such as urinary, erectile, and bowel functions.

The function predictor 6 selects one or more treatment models from a data store of treatment models 22 to predict future values by body function. The function predictor can determine values for short-term function, e.g. less than 24 months after selection of a treatment option, or determines values for long-term function. The treatment models are based on treatment options for a disease profile and are constructed from survey data from available evidences such as journal articles, public health records, and hospital and research databases. Treatment models are constructed using statistical techniques such as logistic regression and/or other suitable statistical regression techniques. The independent or predicted values are body function or dysfunction in future time, and the dependent values include responses to questions, and can include measures from the disease profile. Models can be constructed for each treatment option or combined using treatment options. For example, prostate cancer treatment options include radical prostatectomy (RP), external beam radiation therapy (EBRT), brachytherapy (BT), and active surveillance (AS). A model of urinary function and a model of erectile function can be constructed separately or as a combined model. The predicted values can be represented as discrete values at pre-determined points in time, e.g. time intervals based on sampling methodologies and/or as a continuous function.

The function predictor computes actual function values for body functions based on the received responses, the disease profile, and the statistical model. The actual function values can be pre-existing, e.g. before or prior to treatment, or during treatment, e.g. at one or more times post initiation of treatment. The actual function values can be recorded and tracked.

The function predictor 6 can generate confidence measures for the predicted values. The confidence measures can be represented as discrete values and/or as continuous functions. For example, confidence measures can be given as two standard deviations, three standard deviations, etc. to the predicted or expected values. Furthermore, the function predictor can revise the predicted values and confidence measures based on tracked actual function values.

The visualization unit 8 constructs a visual display of the predicted values for each function of the treatment. The visual display displays predicted values by time. The display can include separate or combined displays for each function. The display can include separate or combined displays for functions by treatment option. The display can be graphical and/or textual. Graphical displays can include line graphs, bar charts, scatter diagrams, contour charts, and the like. The displays can be monochrome or color. The displays can include different symbols by function, treatment option, predicted values, and/or confidence measures. The display device 12 displays the visualized display. Furthermore the visualized display can be interactive with the operator, e.g. patient and/or healthcare practitioner, adding and/or removing functions and/or treatments options to the display. Other options can include changing the time frame from short-term to long-term.

The various units or modules 2, 6, 8 are suitably embodied by an electronic data processing device, such as the electronic processor or electronic processing device 14 of a workstation 24, or by a network-based server computer operatively connected with the workstation 24 by a network 26, or so forth. Moreover, the user interface, the disclosed predicting and tracking, and visualization techniques are suitably implemented using a non-transitory storage medium storing instructions (e.g., software) readable by an electronic data processing device and executable by the electronic data processing device to perform the disclosed predicting and tracking techniques.

The workstation 24 includes the electronic processor or electronic processing device 14, the display 12 which displays the visualized display, questions, menus, panels, and user controls, and the at least one input device 10 which inputs the healthcare practitioner and/or patient selections. The workstation 24 can be a desktop computer, a laptop, a tablet, a mobile computing device, a smartphone, and the like. The input device 10 can be a keyboard, a mouse, a microphone, and the like. The display device 12 can include a computer monitor, a television screen, a touch screen, tactile electronic display, Cathode ray tube (CRT), Storage tube, Flat panel display, Vacuum fluorescent display (VF), Light-emitting diode (LED) displays, Electroluminescent display (ELD), Plasma display panels (PDP), Liquid crystal display (LCD), Organic light-emitting diode displays (OLED), and the like.

The data stores such as the treatment models 22, standardized questions 16, and patient tracking 20 can be implemented on magnetic media such a floppy disk, a magnetic hard disk drive, a solid state hard disk, flash memory, a USB drive, and the like. The data store can include a single drive or multiple drives. The data store can be organized as objects, files, records, and the like. The data store can be structured such as a relational database, an object oriented database, a file system, combinations, and the like. The data stores, units, and processing devices can be embodied on a single computer, multiple servers and/or storage devices operatively connected by the Internet and/or other network.

With reference to FIGS. 2A-2C, example visualizations of predicted prostate cancer treatment options by body function 28 are illustrated. FIG. 2A shows erectile function; FIG. 2B shows urinary function; and FIG. 2C shows bowel function. The examples are illustrated for multiple treatment options 30, e.g. RP, EBRT, BT and AS. Time is illustrated in months along the horizontal axis. The vertical axis is the level of body function normalized between 0-1. Each treatment is represented as a separate line graph with different symbols 30 showing discrete values 32 predicted at 1, 2, 6, 12, and 24 months.

In FIG. 2A, the patient, in one example, shows an initial (pretreatment) or actual body function (pre-existing condition) 34 of 90% or 0.9 erectile function. The initial or actual value is computed by the function predictor based on the responses received, from the patient in the example, to the standardized questionnaire. After 1 month post treatment selection, a loss of approximately 57% (confidence interval from 3% to 99%) of function with RP treatment is predicted for the patient, a loss of 20% (confidence interval from 3% to 71%) with the EBRT treatment, a loss of 14% (confidence interval from 0% to 99%) with BT treatment, and no change with AS. With the BT treatment, eventual recovery returns to pre-treatment function after one year. With RP and EBRT after 24 months, the expected function is approximately 60%. The values of body functions are predicted for the diagnosed patient and displayed as line graphs. FIG. 2B shows the initial value and predicted values for urinary function of the patient for the multiple treatment options. FIG. 2C shows the initial value and predicted values for bowel function. Each graph includes a line graph 36 for the function of predicted values for each treatment option for a function.

FIGS. 3A-3D illustrate example visualizations of short-term tracking of erectile function with confidence measures 38 for a patient with prostate cancer who chose EBRT treatment. In FIG. 3A pre-treatment EBRT expected or predicted values 36 are indicated with a 50% line graph. Confidence measures 38 are expressed as lines graphs at two standard deviations of 97.5% and 2.5%. Discrete values indicated are based on normal tracking intervals of 1, 2, 6, 12, and 24 months. In FIG. 3B, a revised or actual function value 44 at one month is computed by the function predictor based on the responses received to the standardize questionnaire at one month, and the disease profile. The before treatment predicted values 36 and confidence measures 38 are overlayed with revised predicted values 40 and revised confidence measures 42 at one month post treatment commencement. The revised predicted values and confidence measures are updated in FIG. 3C at 2 months, and in FIG. 3D at 6 months. The graphs show a narrowing of the confidence measures.

The revised predicted values although shown as constant, could be revised upward or downward based on the received responses and the computed actual function value. FIG. 3B shows greater than expected side effects in the change to erectile function with the predicted value prior to treatment at 65%, and the one month determined value as 55%. After the first month, the patient erectile function tracks close to the revised predicted values in

FIGS. 3C and 3D at 55%.

With reference to FIG. 4, an embodiment of a method of predicting and tracking patient body functions is illustrated. In a step 46, patient responses to the standardized questions are received by the user interface 2. The standardized questions are selected from the standardized questions data store 16 based on the disease profile other than the disease for which the patient is selecting treatment options or is tracking treatment/recovery progression. The received responses can be stored for tracking.

In a step 50, predicted patient function is computed by the function predictor 6 for each function based on the received responses, a disease profile (if present), treatment option, and a statistical model constructed from population based surveys. The current or actual patient function is computed by the function predictor for each function based on the received responses, disease profile, and treatment option. The current or actual patient function values can be stored and tracked. The statistical models are retrieved from the treatment model data store 22. The statistical models can be separated by treatment option, and/or by time frame such as short-term or less than 24 months, and long-term or greater than 24 months. The predicted patient function can include confidence measures. The predicted patient function and confidence measures can be revised based on track received responses post treatment selection or the current or actual body function values, and can be continually revised with each new tracked set of responses or actual body function values.

The predicted patient function and optionally the confidence measures are visualized by the visualization unit 8 in a step 52. The visualized display includes at least one body function for one treatment option. The visualized display can include multiple body functions and/or treatment options. The visualization can include line graphs of the predicted values and/or text. The visualization can include color. The visualization can include different symbols representing the predicted values and/or confidence measures. The visualization can include different graphical representations such as line graphs, bar charts, scatter diagrams, contour diagrams, and the like. The visualization can include tracked values and/or confidence measures. The visualization can be interactive with the operator selecting inclusion of different predicted values, confidence measures, time measures, etc. The visualized display is displayed on the display device in a step 54. Alternatively, the visualized display can be stored for later reference.

In a decision step 56, the process can be repeated at different time intervals during patient follow-up. The tracked function values can be included in the updated visualization with the revised predicted values and revised confidence measures.

In one embodiment, the one or more processors 14, are programmed or configured to implement the method of FIG. 4. A non-transitory computer readable medium, such as a memory associated with the one or more processors, or a portable memory such as a DVD, etc. carries software for controlling one or more processors to perform the method of FIG. 4.

It is to be appreciated that in connection with the particular illustrative embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof. That is to say, it will be appreciated that various of the above-disclosed and other features and functions, or alternatives thereof, may be desirably combined into many other different systems or applications, and also that various presently unforeseen or unanticipated alternatives, modifications, variations or improvements therein may be subsequently made by those skilled in the art which are similarly intended to be encompassed by the following claims.

1. A medical information system, comprising:
a user interface unit which receives responses of a patient diagnosed with a disease to standardized questions being based on a disease profile of the patient and pertaining to body functions of the diagnosed patient;
a function predictor which computes at least an actual function value for the at least one body function based on the received responses, the disease profile, a treatment option and computes predicted function values for the at least one body function based on the actual function value, the disease profile, the treatment option, and a statistical model constructed from population based survey results;
a visualization unit which constructs a visual display of the predicted values of the at least one body function for the diagnosed patient; and
a display device which displays the visual display.

2. The system according to claim 1, wherein the function predictor is arranged to computes a confidence measure for the predicted values.

3. The system according to claim 1, wherein the function predictor is arranged to computes predicted function values for a plurality of treatment options.

4. The system according to claim 1, wherein the at least one body function includes a plurality of body functions.

5. The system according to claim 1, wherein the predicted function values include values for 24 months following a treatment option selection by the diagnosed patient.

6. The system according to claim 1, wherein the diagnosed disease includes cancer.

7. The system according to claim 1, wherein the visual display includes line graphs of the predicted function values for the diagnosed patient.

8. The system according to claim 1, wherein the visual display includes lines graphs of the confidence measures.

9. The system according to claim 1, wherein the system is arranged such that the actual function value computed by the function predictor is recorded and tracked.

10. The system according to claim 9, wherein the system is arranged such that the predicted function values are revised based on tracked actual function values.

11. A method of providing medical information for patients diagnosed with a disease, the method comprising:
receiving responses of a patient diagnosed with a disease to standardized questions being based on a disease profile of the patient and pertaining to body functions of the diagnosed patient;
computing at least an actual function values for at least one body function based on the received responses, a disease profile, a treatment option and computing predicted function values for the at least one body function based on the actual function value, the disease profile, the treatment option and a statistical model constructed from population based survey results;
constructing a visual display of the predicted values of the at least one body function for the diagnosed patient; and
displaying the visual display.

12. The method according to claim 11, further including:
computing a confidence measure for the predicted values;
wherein constructing the visual display includes the computed confidence measures and displaying includes displaying the computed confidence measures.

13. (canceled)

14. The method according to claim 11, wherein constructing the visual display includes constructing line graphs of the predicted values of body functions for the diagnosed patient and displaying includes the constructed line graphs of predicted values.

15. The system according to claim 11, wherein constructing the visual display includes constructing lines graphs of the confidence intervals and displaying includes the constructed lines graphs of the confidence measures.

16. (canceled)

17. (canceled)

18. A non-transitory computer-readable storage medium carrying software which controls one or more electronic data processing devices to perform the method according to claim 11.

19. (canceled)

20. (canceled)
